(19) United States
(12) Patent Application Publication
(10) Pub. No.: US 2003/0129282 A1
(43) Pub. Date: Jul. 10, 2003

(54) Frozen drink mixes

(76) Inventors: Hector A. Solorio, East Amherst, NY (US); Balasundaram P. Nachimuthu, Amherst, NY (US); Dennis Flahive, Buffalo, NY (US)

Correspondence Address: KENYON & KENYON, Suite 700, 1500 K Street, N.W., Washington, DC, 20005, US

(21) Appl. No.: 10/228,989

(22) Filed: Aug. 28, 2002

Related U.S. Application Data
(60) Provisional application No. 60/315,926, filed on Aug. 31, 2001.

(51) Int. Cl. A23L 1/00

(52) U.S. Cl. 426/102

(57) ABSTRACT

A frozen drink mix is described that does not substantially separate after being frozen. These frozen drink mixes preferably have high fruit content, fruit insoluble solids with small particle size and high viscosity.

### CROSS-REFERENCE TO RELATED APPLICATIONS

This application claims the benefit of provisional application Serial No. 60/315,926, filed Aug. 31, 2001, which is incorporated herein by reference in its entirety.

### FIELD OF THE INVENTION

The present invention relates to frozen drink mixes that achieve a desired stability, such that frozen mixed drinks made from the drink mixes do not substantially separate after the drinks have been mixed.

### BACKGROUND OF THE INVENTION

Frozen drink mixes are generally mixed or “slushed” with ice and alcohol. For example, margarita mix is generally mixed with tequila and ice, and piña colada and daiquiri mixes are each mixed with rum and ice. Alcohol is not necessary, however, as in the case of “virgin” frozen drinks, where the drink mix is mixed with ice, but no alcohol. In making a frozen drink, the ice is often crushed after mixing with the drink mix (and optionally alcohol), although it can be optionally crushed prior to mixing or slushed in a suitable machine with the addition of water.

If not served and consumed quickly enough, frozen drinks known in the art separate into a viscous layer comprising insoluble fruit solids and/or ice, and a mostly liquid phase, in the standing blender or serving glass. This phenomenon is especially a problem in the relatively warm environments (where frozen drinks are often consumed), due to the surrounding air temperature melting the crushed ice. However, independent of the melting of ice, these types of drinks separate over a relatively short period of time.

### SUMMARY OF THE INVENTION

The present inventors have found that when frozen drink mixes containing a high fruit content, which translates into a high fruit solids content, and/or small particle size (of the fruit insoluble solids) and/or high viscosity, are used to make frozen drinks, the drinks do not separate to the same extent or as quickly as frozen drinks made from drink mixes known in the art.

Depending on the type and amount of fruit in the present drink mixes, the fruit solids content may be high enough to achieve the desired result of forming a relatively stable drink mix that does not separate as quickly, when formed into a frozen drink, as frozen drinks made from known drink mixes. In cases where the fruit solids content does not itself achieve this result, then the average particle size of the insoluble fruit solids can be reduced, by high shear blending or homogenization, to achieve the desired results. Other ingredients, such as emulsifiers and/or stabilizers, may optionally be added to the drink mixes of the present invention such as sugar, carbohydrates or gums, to achieve the desired stability through increased viscosity of the final frozen drink.

Additionally, one or more sweeteners, coloring agents, flavoring enhancers, and/or other ingredients known to those skilled in the art for drink mixes or juices, may optionally be added to the drink mixes of the present invention.

### DETAILED DESCRIPTION

The present invention will now be described in detail for specific preferred embodiments of the invention, it being understood that these embodiments are intended only as illustrative examples and the invention is not to be limited thereto.

The present invention relates to frozen drink mixes that provide stable frozen drinks, which do not substantially separate as compared to frozen drinks made from mixes presently on the market, after the drink is made. Devices have been described in the art that form frozen drinks and keep the mixture of the frozen drink uniform by continuous mixing. However, even these freezer machines (such as Taylor and Granita machines) do not keep the frozen drinks from separating after the product is served. The drink mixes of the present invention are therefore also advantageous in that when they are used in drink machines or a blender with crush iced, the resulting frozen drinks do not separate as quickly after serving as they would if they were made from presently known drink mixes.

The amounts of each ingredient described herein are by weight percent of the total mixture, whereas the amount or degree of melting or separation is based on volume percent.

When drink mixes of the present invention are made into a frozen drink, they separate into different layers only up to about 35% (preferably less than about 25%, more preferably, less than 10% by volume) over the same period of time that a drink made from known drink mixes which would separate typically by 50% or more by volume. The time period for separation varies depending on the temperature of the glass, mixer or other container, and the temperature or other conditions of the surrounding air that affect the rate of melting. However, the environment being equal, frozen drinks made according to the present invention preferably separate more than about 25% slower by volume than drinks made from drink mixes known in the art, preferably more than about 50% slower, more preferably more than about 75% slower.

One embodiment of the present invention provides frozen drink mixes that include a fruit content of about 15 to about 75% by weight. Preferably, the frozen drink mixes of the present invention include a total solids content of about 15% to about 45% by weight. Preferably, the fruit solids content ranges from about 1.5 to about 9%. Generally, the insoluble fruit solids ranges from about 0.3 to about 2% or higher. Preferably, the insoluble fruit solids is at least 0.5%, more preferably at least 0.9%.

Another embodiment of the invention provides reduced particle size of the fruit insoluble solids (fiber). Reducing particle size aids in decreasing separation. The particle size of strawberry solids is preferably below about 700 microns. The particle size of mango solids is preferably below about 300 microns. The particle size can be reduced either before or after “freezing.” Preferably, the particle size is reduced before freezing, such as with a high shear pump, high shear blender or a homogenizer.

Another embodiment of the invention provides increased viscosity. Increasing viscosity aids in decreasing separation. Preferably, the viscosity ranges from about 100 to about 2000 cp, more preferably from about 200 to about 1000 cp. Viscosity enhancers are known in the art and may include, for example, sugars, starches, maltodextrins, and gums.

Frozen drink mixes of the present invention may be any type of mix that may be combined with ice, particularly those containing fruit, such as bar mixes (margaritas, daiquiris, pina coladas, etc), smoothies, and the like. The term “frozen” drink mixes is intended to mean that the mixes result in frozen drinks when mixed with crushed ice or when slushed in a suitable machine, not that the mixes themselves are necessarily frozen. However, the mixes of the present invention may optionally be prepared and stored in the form of a frozen concentrate, if desired.

The fruit in the frozen drink mixes may be any kind of fruit that would create a desirable taste alone or in combination with other fruit and/or various types of alcohol. The drink mixes may be water and/or milk product based. The drink mixes may be non-alcoholic, to which alcohol may be later added at the time of preparing the frozen drink (if desired), or the drink mixes may be manufactured containing alcohol.

An embodiment of the present invention includes margarita mixes that include from about 17 to about 35%, more preferably about 12 to about 25%, even more preferably about 23 to about 25.5%, most preferably about 24.2% by weight fruit. Preferably, the total solids content of the margarita mixes of the present invention is from about 18 to about 25%, more preferably about 19 to about 24%, even more preferably about 20.5 to about 22.5%, most preferably about 21.5% by weight. Preferably, the total fruit solids content of the margarita mixes of the present invention is from about 1.8% to 3.0%, more preferably about 1.9 to about 2.9%, more preferably about 2.0 to about 2.7%, and most preferably about 2.4% by weight.

Another embodiment includes strawberry daiquiri mixes that include from about 40 to about 55%, more preferably about 46 to about 53%, even more preferably about 49.5 to about 51.5%, most preferably about 50.5% by weight fruit. Preferably, the total solids content of the strawberry daiquiri mixes of the present invention is from about 33 to about 41%, more preferably about 34.5 to about 39.5%, even more preferably about 36 to about 38%, most preferably about 37% by weight. The fruit solids content of the strawberry daiquiri mixes of the invention is preferably from about 4.0 to about 6.6%, more preferably about 4.6 to about 6.4%, even more preferably from about 4.9 to about 6.2%, and most preferably about 4.1% by weight.

Piña colada mixes according to the present invention include from about 50 to about 75%, more preferably about 60 to about 72%, even more preferably about 65 to about 67%, most preferably about 66% by weight fruit. Preferably, the solids content of the piña colada mixes of the present invention is from about 27 to about 35%, more preferably about 28.5 to about 33.5%, even more preferably about 30 to about 32%, most preferably about 31% by weight. Preferably, the fruit solids content of the piña colada mixes of the present invention is from 5.0 to 9.0%, more preferably about 6 to about 8.7%, even more preferably about 6.5 to about 8.1%, and most preferably about 7.3% by weight.

The fruit of the present invention may be in the form of puree, juice, whole fruit and the like, and combinations thereof. Non-limiting examples of suitable fruit that may be used in various forms in accordance with the present invention include for example, berries (such as raspberries, strawberries, gooseberries, boysenberries, blueberries, cranberries, blackberries and the like), cherries, citrus (such as lemons, limes, grapefruit, and the like), apples, passion fruit, pears, apricots, nectarine, grapes, mandarins, tangerines, oranges, mint, plums, watermelons, cantaloupes, bananas, peaches, tropical fruits (such as mangos, kiwis, pineapples, papayas, coconuts, and the like), and combinations thereof.

Preferred fruit of the present inventions includes coconuts, apples, pears, lemons, limes, mandarins, grapefruit, cranberries, oranges, strawberries, grapes, kiwis, pineapples, tangerines, passion fruit, mangos, guava, raspberries, and cherries. The particularly preferred fruit of the present invention depends on what type of frozen drink mix is being prepared. For example, in margarita mixes, preferred fruits include lemon, lime and the like, whereas in piña colada mixes, fruits include coconut, pineapple and other tropical fruit.

Frozen drink mixes of the present invention optionally contain one or more stabilizers and/or emulsifiers to help achieve a frozen drink having a desired stability. Specifically, the one or more emulsifiers and stabilizers interact with the naturally occurring gums and fibers of the fruit in the drink mixes to achieve the functional property of slow separation and/or melting.

In particular, the frozen drink mixes of the present do not substantially separate upon standing at about room temperature for a period of time over which drinks mixed using prior mixes would have separated by 50%. A frozen mixed drink has not substantially separated if less than about 35% of the drink by volume is in a liquid layer that appears visibly separate from the viscous layer. Alternatively, frozen drinks made using the frozen drink mix of the present invention have not substantially separated if they have separated less than about 15% by volume, over a period of time in which drinks mixed using prior mixes would have separated by 25%.

Non-limiting examples of the one or more stabilizers that may be optionally added to the drink mixes of the present invention include, for example, pectin, xanthan gum, alginates, carboxymethyl cellulose, guar gum, locust bean gum, carrageenan, cellulose gums, modified cellulose, and the like, and combinations thereof. The amount and type of the one or more stabilizers depends on various factors, including the amount and type of fruit in the drink mix, the amount of fruit solids contained in the fruit, the amount and type of emulsifiers (if any), and the desired relative stability of the frozen drinks being made.

According to an embodiment of the invention, such as when pectin is used, the amount of stabilizer used in the drink mixes is from about 0.01 to about 3% of the total weight of the frozen drink mix, preferably about 0.5 weight % to about 2 weight %. According to another embodiment of the invention, such as when carboxymethylcellulose is used, the amount of stabilizer used in the drink mix is from about 0.05 to about 1%, preferably about 0.2%.

Preferred stabilizers include pectin, especially when margarita mixes are being formed, and carboxymethylcellulose, especially when piña colada mixes are being formed. The amount or type of stabilizer varies depending on the fruit used and the type of drink mix being formed. One or more stabilizers may also be added to the drink mixes of the present invention for purposes other than those stated above, such as for obtaining the desired viscosity and the organoleptic sensation associated therewith.

The amount of the one or more emulsifiers, when present, is preferably from about 0.01 weight % to about 3 weight % of the product, preferably about 0.02 weight % to about 1 weight %, more preferably about 0.03 to about 0.6%. According to one embodiment, emulsifier is present in an amount of from about 0.02 to about 0.04%, preferably about 0.4%.

Examples of emulsifiers that may be useful in accordance with the present invention include for example, lecithin, mono-, di-, or polyglycerides of fatty acids, such as monostearin and monopalmitin; polyoxyethylene ethers of fatty esters of polyhydric alcohols, such as polyoxyethylene ethers of sorbitan monostearate (polysorbate 60) or the polyoxyethylene ethers of sorbitan distearate; fatty esters of polyhydric alcohols such as sorbitan monostearate; mono- and diesters of glycols such as propylene glycol monostearate and propylene glycol monopalmitate, succinylated monoglycerides; and the esters of carboxylic acids such as lactic, citric and tartaric acids with the mono- and diglycerides of fatty acids such as glycerol lacto palmitate and glycerol lacto stearate, and the like, and mixtures thereof. Further non-limiting examples of suitable emulsifiers include for example, gum acacia, modified food starches (such as, alkenylsuccinate modified food starches), anionic polymers derived from cellulose (such as, carboxymethylcellulose), gum Arabic, carob bean gum, gum karaya, carrageenan, propylene glycol esters of alginic acid, polysorbates, gum ghatti, modified gum ghatti, xanthan gum, tragacanth gum, guar gum, locust bean gum, pectin, and the like, and mixtures thereof. Many blends of emulsifiers are commercially available. The amount or type of emulsifier varies depending on the amount and type of fruit used and the type of drink mix being formed. For example, a preferred emulsifier in the case of piña colada mixes includes propylene glycol alginate.

The frozen drink mixes according to the present invention may further contain one or more aromatic and/or flavoring substances, such as fruit flavors or sweeteners such as carbohydrates, dextrose syrup or maltodextrins.

The amount of aromatic or flavoring substance, if present, is preferably about 0.1 weight to about 3.0 weight % of the product, preferably about 0.01 to about 2%, more preferably about 0.2 weight % to about 0.6 weight %. The aromatic or flavoring substance may be natural and/or artificial. Examples of flavoring substances that may be used include conventional flavoring substances for alcoholic beverage drinks and drink mixes, such as condensed milk, vanilla, Kahlua®, coffee, mocha, fruit flavors or extracts, liqueur flavor and the like, and combinations thereof. Preferred flavoring agents include fruit flavors or extracts, which can be used to enhance the fruit flavors in the drink mix. These preferred fruit flavors or extracts may be in combination with botanical flavors such as tea flavors. Green tea or black tea flavors in particular have an appealing taste in combination with fruit juices.

Preferred fruit flavors include for example, citrus flavors, apple, pear, lemon, lime, mandarin, grapefruit, cranberry, orange, strawberry, grape, kiwi, pineapple, tangerine, passion fruit, mango, guava, raspberry, coconut and cherry. Citrus flavors, preferably grapefruit, orange, lemon, lime, mandarin, tangerine and juices of mango, passion fruit, and guava, or mixtures thereof are most preferred. The combination of flavors depends on the type of drink mix being made and the desired final flavor.

Suitable fruit flavors can be derived from natural sources such as fruit juices, juice concentrates and flavor oils, or can be synthetically prepared. However, natural fruit flavors are preferred.

Sweeteners may be optionally added to the frozen drink mix (in addition to sweeteners contained in other ingredients, such as sugars in the fruit) to obtain the desired sweetness and/or viscosity. Examples of sweeteners include granulated sugar (preferably fine granulated or extra fine granulated sugar), sucrose, sugar liquid, corn syrup including dextrose and high fructose corn syrup, artificial sweeteners, low or no calorie sweeteners, and the like. Sugar alcohols can also be used in the frozen drink mixes of the present invention. These sugar alcohols include for example, sorbitol, mannitol, and xylitol. Sugar alcohols are not generally used as the sole sweetener, however, because in the levels required to sweeten beverages, they have a side effect of flatulence or related gastrointestinal related problems. Preferred sweeteners include invert sugar, high fructose corn syrup, and sucrose (liquid or granulated).

The amount of sweetener, when present, is preferably about 4 weight % to about 50 weight % of the product, preferably about 15 weight % to about 40 weight %.

One or more coloring agents, such as dyes, can be used to produce and/or enhance the desired color of the drink mix. The coloring agent may be natural and/or artificial. If a coloring agent is used, the coloring agent is preferably less than about 3% of the drink mix and more preferably about 0.01-2% of the drink mix.

Sufficient water may be added to the present drink mixes to achieve the desired consistency and fruit concentration. Water added to the frozen drink mixes (not including water from other ingredients, such as juice and sweetener, for example) is preferably from about 4% to about 80% of the frozen drink mix. Preferred amounts depend on the amount and type of fruit and the type of frozen drink mix being made. For example, the amount of water added to a pin a colada frozen drink mix may be from about 30 to about 55%, preferably from about 40 to about 50%, more preferably about 44.5% by weight. The amount of water added to a strawberry daiquiri frozen drink mix may be from about 4 to about 14%, preferably from about 6 to about 12%, more preferably about 8.5% by weight. The amount of water added to a margarita frozen drink mix may be from about 50 to about 80%, preferably from about 60 to about 70%, more preferably about 64.5% by weight.

The frozen drink mixes of the present invention may optionally contain one or more sources of fat. The amount of fat in the product may be from about 0.1 weight % to about 5 weight %, preferably about 0.2 weight % to about 1 weight %. Examples of fats that may be used include vegetable oils such as soy bean oil, sunflower oil, canola oil, modified canola oil, palm kernal oil, coconut oil, dairy fats, dairy cremes and the like. Preferred fats include soy bean oil, palm kernal oil and coconut oil.

The frozen drink mixes of the present invention may also contain one or more food acids, selected from the group consisting of citric acid, tartaric acid, malic acid and lactic acid, and the like, and combinations thereof. The one or more food acids are preferably present in an amount of less than about 1%, preferably less than about 0.3%.

The frozen drink mixes of the present invention may optionally contain whey protein isolate. Such drink mixes would have the advantage of supplying amino acids as well as calcium. The quantity of whey protein isolate that is utilized can vary widely. In the present invention, the amount of whey protein isolate may vary from 0% to 2%. According to one embodiment of a frozen piña colada mix, the amount of whey protein isolate is preferably from about 0.001% to about 0.01%, more preferably about 0.005% by weight.

Whey protein isolate may be supplied by numerous commercial sources. Commercially available sources of whey protein isolate that are useful in the present invention are ALACEN 895 from New Zealand Milk Products, Inc., of Santa Rosa, Calif.; Provon-190 from Avonmoor Ingredients, Inc., of Monroe, Wis., and LACPRODAN from MD Foods Ingredients amba, Denmark.

The frozen drink mixes of the present invention may be manufactured and/or sold in a liquid form, a frozen concentrated form, a liquid concentrated form or any other form known in the art.

The frozen drink mixes of the present invention may be prepared according to conventional methods in the art for preparing mixers or juices, as would be apparent to those skilled in the art based on the ingredients specifically set forth herein. In particular, the various components can be mixed with each other, homogenized or subjected to high shear blending to achieve desired particle size, and, if alcohol is part of the drink mix itself, depending on the alcohol content, the mix may be optionally pasteurized. In the case of higher alcohol percentages, pasteurization would be less necessary. After preparation, the beverage is packaged, preferably in an aseptic container.

In one embodiment, water is first added to a batch tank and various ingredients are added to the batch tank thereafter and the ingredients are mixed. The pH and Brix value of the mixture is monitored and maintained at desired values.

A premix of certain ingredients may be prepared ahead of time by combining certain ingredients together, and preferably blending them for a period of from about 5 to about 30 minutes. For example, it may be advantageous to combine pectin and sugar in a premix or to combine emulsifiers, and/or other thickeners with sugar in a premix, so as to achieve a frozen drink mix having desirable aesthetic and consistency properties.

The present invention will now be described in detail with respect to showing how certain specific representative embodiments thereof may be made, apparatus and process steps being understood as examples that are intended to be illustrative only. In particular, the invention is not intended to be limited to the methods, ingredients, conditions, process parameters, apparatus and the like specifically recited herein.

### EXAMPLES

The following examples demonstrate embodiments of concentrated mixes. These mixes can then be mixed with ice or water (subsequently frozen) in the desired proportion to produce a frozen beverage ready for consumption. Typically, the ratio of mix to ice or water ranges from about 1:1 to about 2:3. In these examples, the ratio of mix to ice is about 5:7.

### Example 1

A margarita mix was prepared from the following ingredients:

| INGREDIENTS | PERCENT BY WEIGHT |
|---|---|
| water | 47.64 |
| corn syrup hi fructose | 9.00 |
| sugar liquid | 14.00 |
| lime juice | 19.20 |
| (or 2.4 lime juice concentrate) | |
| lemon pulp cells | 5.00 |
| acid citric ANHY granular | 0.80 |
| sodium citrate | 0.08 |
| flavor lemon nat emulsion | 0.09 |
| extra fine granulated sugar | 2.78 |
| pectin | 1.39 |
| oil | 0.02 |

Margarita mixer was made having the above ingredients, using the following procedure:

1. Cold water was metered into batch tank, high shear 100%, sweep mixer 90%, heat temperature 0° F., hold time 0 seconds.

2. A premix of the extra fine granulated sugar, pectin and high stability oil, was added at high shear 100%, sweep mixer 90%, heat temperature 0° F., hold time 0 seconds.

3. High fructose corn syrup was metered into the batch tank. High sheer 0%, sweep mixer 90%, heat temperature 0° F., hold time 0 seconds.

4. Liquid sugar was metered into the batch tank. High sheer 0%, sweep mixer 90%, heat temperature 0° F., hold time 0 seconds.

5. Lime concentrate was added to the batch tank. High sheer 0%, sweep mixer 90%, heat temperature 0° F., hold time 0 seconds.

6. Lemon pulp cells were added to the batch tank. High sheer 0%, sweep mixer 90%, heat temperature 0° F., hold time 0 seconds.

7. Citric acid was added to the batch tank. High sheer 0%, sweep mixer 90%, heat temperature 0° F., hold time 0 seconds.

8. Sodium citrate was added to the batch tank. High sheer 0%, sweep mixer 90%, heat temperature 0° F., hold time 0 seconds.

9. Lemon flavor was added to the batch tank. High sheer 0%, sweep mixer 90%, heat temperature 0° F., hold time 2 minutes.

The product specifications are as follows: pH about 2.4 to about 3.0, Brix about 20.5 to about 22.5 (Digital Refractometer), the batch was processed at 205° F. at 1600 gal/hr using the 4 second (short) holding tube tubular UHT processor.

The premix was made by the following procedure. To the ribbon blender, the following ingredients were added granulated sugar, pectin and high stability oil. The ingredients were then blended for 15 minutes and bagged.

### Example 2

A strawberry daiquiri mix was prepared from the following ingredients:

| INGREDIENTS | PERCENT BY WEIGHT |
|---|---|
| Water | 1.74 |
| corn syrup hi fructose | 39.60 |
| sugar liquid | 7.41 |
| lime juice | 8.00 |
| (or 1% lime juice concentrate) | |
| lemon pulp cells | 2.50 |
| acid citric ANHY granular | 0.30 |
| sodium citrate | 0.05 |
| color red (FD & C 40) | 0.016 |
| flavor strawberry natural | 0.40 |
| puree strawberry frozen | 40.00 |

Strawberry daiquiri mixer was made having the above ingredients, using the following procedure:

1. Cold water was metered into batch tank, high shear 0%, sweep mixer 90%, heat temperature 0° F., hold time 0 seconds.

2. Liquid sugar was metered into the batch tank. High sheer 0%, sweep mixer 90%, heat temperature 0° F., hold time 0 seconds.

3. High fructose corn syrup was metered into the batch tank. High sheer 0%, sweep mixer 90%, heat temperature 0° F., hold time 0 seconds.

4. Strawberry puree was added to the batch tank. High sheer 0%, sweep mixer 90%, heat temperature 0° F., hold time 0 seconds.

5. Lime concentrate was added to the batch tank. High sheer 0%, sweep mixer 90%, heat temperature 0° F., hold time 0 seconds.

6. Lemon pulp cells were added to the batch tank. High sheer 0%, sweep mixer 90%, heat temperature 0° F., hold time 0 seconds.

7. Citric acid was added to the batch tank. High sheer 0%, sweep mixer 90%, heat temperature 0° F., hold time 0 seconds.

8. Sodium citrate was added to the batch tank. High sheer 0%, sweep mixer 90%, heat temperature 0° F., hold time 0 seconds.

9. Red color was added to the batch tank. High sheer 0%, sweep mixer 90%, heat temperature 0° F., hold time 0 seconds.

10. Strawberry flavoring was added to the batch tank. High sheer 0%, sweep mixer 90%, heat temperature 0° F., hold time 2 minutes.

The product specifications are as follows: pH about 2.7 to about 3.3, Brix about 36 to about 38 (Digital Refractometer), the batch was processed at 205° F. at 1600 gal/hr using the 4 second (short) holding tube tubular UHT processor.

### Example 3

A piña colada mix was prepared from the following ingredients:

| INGREDIENTS | PERCENT BY WEIGHT |
|---|---|
| water | 32.133 |
| corn syrup hi fructose | 7.50 |
| sugar liquid | 19.067 |
| coconut milk aseptic | 9.00 |
| juice pineapple | 21.00 |
| (or 8.5 pineapple juice concentrate) | |
| crushed pineapple | 6.000 |
| flavor piña colada art | 0.800 |
| extra fine granulated sugar | 3.320 |
| whey protein isolate | 0.50 |
| propyl glycol alginate HVF | 0.400 |
| carboxymethylcellulose | 0.200 |
| acid malic | 0.080 |

A piña colada mixer was made having the above ingredients, using the following procedure:

1. Hot water (in an amount of about 33% of the total final mixer) having a temperature of 155° to 165° F. was metered into batch tank, high shear 90%, sweep mixer 90%, heat temperature 165° F., hold time 0 seconds.

2. Coconut milk was added to the batch tank. High shear 90%, temperature 160° to 170° F.

3. A premix of the extra fine granulated sugar, whey protein isolate, propylene glycol alginate, carboxymethyl cellulose and malic acid was added at high shear 90%.

4. The slurry was homogenized at 500/3000 psi.

5. The batch was transferred to (unheated) aseptic mix tanks.

6. The remaining water (about 11.633% of the total mixer) was added at a temperature of less than 100° F., with a hold time of 0 seconds.

7. Piña colada flavor was added to the batching tank, high shear 0%, sweep mixer 70%, temperature below 125′ F, hold time 1 minute.

8. Pineapple pieces were then added.

The product specifications are as follows: pH about 3.8 to about 4.1, Brix about 30 to about 32 (Digital Refractometer), the batch was processed at 205° F. at 1600 gal/hr using the 4 second (short) holding tube tubular UHT processor.

The premix was made by the following procedure. To the ribbon blender, the following ingredients were added:

1. granulated sugar,

2. whey protein isolate,

3. propylene glycol alginate, and

4. carboxymethylcellulose and malic acid.

The ingredients were then blended for 20 minutes and bagged.

### Examples 4-12 and Comparative Examples 1-2

### Mango Mix

Examples 5-7 demonstrate the reduction of separation at higher fruit concentration. Examples 8-10 demonstrate the reduction of separation at higher levels of sugar. Examples 11-12 demonstrate the reduction of separation due to the use of a different variety of mango (Mexican variety).

In each of Examples 5-12 and the subsequent Examples (except where noted), the mix was pre-blended in a Vita Mix blender (model VMO115A) at 66% speed for one minute to simulate high shear blending at the plant level. Each sample was then frozen by blending 5 oz of concentrate with 7 oz of ice or water. When the concentrate was blended with ice, the final mix was blended in a standard blender for approximately 30 seconds to crush the ice and produce the frozen drink. When the concentrate was blended with water, the final mix was placed in a freezer machine (such as Taylor or Granita) until properly slushed before serving/testing. Separation was then measured by filling a 1000 ml graduated cylinder at least half way with the prepared sample, allowing the sample to sit at room temperature for one hour, and measuring the amount of transparent liquid that settled to the bottom of the cylinder.

Examples 4, 13, 17, 21, and 27a plant-processed but not pre-blended.

TABLE 1
Mango Mix

| | | | | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|
| Ingredient | Ex. 4 | Comp. 1 | Comp. 2 | % | % | % | % | % | % | % | % |
| water | 38.06 | | | 38.06 | 45.06 | 53.06 | 33.06 | 40.06 | 48.06 | 38.06 | 33.06 |
| sugar liquid | 0 | | | 0 | 0 | 0 | 0 | 0 | 0 | 0 | 0 |
| Mango puree (Philipines-Variety 1) | 35 | | | 35 | 28 | 20 | 35 | 28 | 20 | 0 | 0 |
| malic acid | 0.25 | | | 0.25 | 0.25 | 0.25 | 0.25 | 0.25 | 0.25 | 0.25 | 0.25 |
| citric acid, anhydrate | 0.25 | | | 0.25 | 0.25 | 0.25 | 0.25 | 0.25 | 0.25 | 0.25 | 0.25 |
| tropic mango flavor | 0.7 | | | 0.7 | 0.7 | 0.7 | 0.7 | 0.7 | 0.7 | 0.7 | 0.7 |
| sugar | 25.74 | | | 25.74 | 25.74 | 25.74 | 30.74 | 30.74 | 30.74 | 25.74 | 30.74 |
| Mango puree (Mexico-Variety 2) | | X | X | | | | | | | 35 | 35 |
| Total | 100 | | | 100 | 100 | 100 | 100 | 100 | 100 | 100 | 100 |
| initial temp | 28.7 | 28.4 | 27.7 | 29.6 | 29.8 | 29.3 | 29.3 | 29.3 | 29.4 | 29.6 | 28.9 |
| ending temp | 31.9 | 40.9 | 35.5 | 38 | 34.6 | 34.1 | 36.1 | 39.2 | 41.3 | 32 | 41.5 |
| total separation (ml) in one hour | 125 | 125 | 60 | 35 | 60 | 90 | 5 | 35 | 30 | 5 | 0 |
| % separation | 26 | 26.6 | 12.3 | 7.29 | 12.3 | 18.95 | 1.02 | 7.3 | 6.25 | 1.04 | 0 |
| Brix | 32.5 | 34.5 | 37.9 | 31.7 | 30.6 | 29.8 | 37 | 39.5 | 34.8 | 31.4 | 36.7 |
| viscosity at 40 F. | 200 | 330 | 980 | 400 | 250 | 173 | 460 | 350 | 230 | 700 | 780 |
| particle size (50% of P/90% of P) | 108/289 | 137/460 | 128/311 | 60/213 | 57/216 | 54/281 | | | | | |
| (microns) | | | | | | | | | | | |

The Mexican mango variety has a higer insoluble fiber content (insoluble solids) providing less of a visual separation than the Philipino variety.
Comp. Ex. 1 = Island Oasis brand Mango Mix.
Comp. Ex. 2 = Maui brand Mango Mix.

TABLE 2
Strawberry Daiquiri

| | Ex. 13 | | | Ex. 14 | Ex. 15 | Ex. 16 |
|---|---|---|---|---|---|---|
| Ingredient | % | Comp. 3 | Comp. 4 | % | % | % |
| water | 11.19 | | | 11.19 | 20.84 | 30.84 |
| HFCS | 39.6 | | | 39.6 | 39.6 | 39.6 |
| sugar liquid | 0 | | | 0 | 0 | 0 |
| lime conc | 1 | | | 1 | 1 | 1 |
| lemon pulp cells | 2.5 | | | 2.5 | 2.5 | 2.5 |
| citric acid | 0.3 | | | 0.3 | 0.3 | 0.3 |
| FD & C red 40 (4% solution) | 0.05 | | | 0.05 | 0.4 | 0.4 |
| strawberry flavor | 0.4 | | | 0.4 | 0.4 | 0.4 |
| sugar | 4.96 | | | 4.96 | 4.96 | 4.96 |
| Strawberry Puree | 40 | | | 40 | 30 | 20 |
| sucrolose | 0 | | | 0 | 0 | 0 |
| pectin | 0 | | added | 0 | 0 | 0 |
| total | 100 | | | 100 | 100 | 100 |
| starting temp F | 27.5 | 27.4 | 28.2 | 26.4 | 26 | 27 |
| ending temp F | 39.3 | 34 | 40 | 44.9 | 44.1 | 37.7 |
| % separation | 4.12 | 21 | 7.2 | 0 | 3 | 13.4 |
| total separation in one hour (ml) | 20 | 150 | 35 | 0 | 15 | 65 |
| viscosity | 380 | 270 | 700 | 810 | 800 | 550 |
| particle size (50%/90% of P) | 338/1023 | 403/1083 | 425/827 | 280/658 | 276/711 | 323/1084 |

Comp. Ex. 3 = Island Oasis brand Margarita Mix.
Comp. Ex. 4 = Maui brand Margarita Mix.

TABLE 3
Pina Colada

| Ingredient | Ex. 17 | Ex. 18 | Ex. 19 | Ex. 20 | Comp. 5 | Comp. 6 |
|---|---|---|---|---|---|---|
| water | 50.93 | 49.63 | 42.12 | | | |
| HFCS | 7.5 | 23.59 | 30 | | | |
| sugar liquid | 0 | 0 | 0 | | | |
| coconut milk | 9 | 9 | 9 | | | |
| pineapple juice concentrate | 8.5 | 8.5 | 8.5 | | | |
| pineapple crushed | 6 | 6 | 6 | | | |
| Pina Colada flavor | 0.8 | 0.8 | 0.8 | | | |
| sugar | 16.09 | 0 | 0 | | | |
| whey protein isolate | 0.5 | 0.5 | 0.5 | | | |
| PGA hvf | 0.4 | 0.4 | 0 | | | |
| CMC | 0.2 | 0 | 0 | | | |
| malic acid | 0.08 | 0.08 | 0.08 | | | |
| sodium citrate | | 1 | 1 | | | |
| Nacl | | 0 | 1 | | | |
| pectin (Danisco pectin AMD | | 0.5 | 1 | | | |
| 789) | | | | | | |
| gum | | | | | | |
| Total | 100 | 100 | 100 | | | |
| Starting Temp F | 29.2 | 25.8 | 28 | 28.5 | 28.8 | 28.2 |
| Ending Temp F | 46 | 39.1 | 38 | 32.4 | 37.8 | 40.8 |
| vol of separation ml in one hour | 0 | 0 | 0 | 0 | 0 | 0 |
| % separation | 0 | 0 | 0 | 0 | 0 | 0 |
| viscosity | | | | 450 | 384 | 500 |

Comp. Ex. 5 = Island Oasis brand Piña Colada Mix
Comp. Ex. 6 = Maui brand Piña Colada Mix

TABLE 4
Banana Mix

| | Ex. 21 | | Comp. 8 | Ex. 22 | Ex. 23 | Ex. 24 | Ex. 25 | Ex. 26 |
|---|---|---|---|---|---|---|---|---|
| Ingredient | % | Comp. 7 | % | % | % | % | % | % |
| water | 43.67 | | 43.67 | 50.47 | 57.47 | 38.47 | 45.47 | 52.47 |
| sugar liquid | 0 | | 0 | 0 | 0 | 0 | 0 | 0 |
| banana puree | 29.8 | | 29.8 | 23 | 16 | 30 | 23 | 16 |
| malic acid | 0.13 | | 0.13 | 0.13 | 0.13 | 0.13 | 0.13 | 0.13 |
| flavor banana | 0.5 | | 0.5 | 0.5 | 0.5 | 0.5 | 0.5 | 0.5 |
| sugar | 25.9 | | 25.9 | 25.9 | 25.9 | 30.9 | 30.9 | 30.9 |
| Total | 100 | 0 | 100 | 100 | 100 | 100 | 100 | 100 |
| starting Temp | 26 | 27.2 | 28.8 | 28.9 | 28.8 | 28.5 | 28.1 | 28.5 |
| ending temp | 30 | 32.9 | 35.3 | 50.3 | 35.6 | 31 | 33.3 | 32.4 |
| total separation ml in 1 hr | 0 | 105 | 0 | 0 | 170 | 0 | 0 | 125 |
| % separation | 0 | 21.88 | 0 | 0 | 37.36 | 0 | 0 | 27.47 |
| % solid content | 33.9 | | 33.9 | 32 | 30.9 | 40.5 | 37.8 | 36.5 |
| Brix | 33.6 | 36.8 | 33.6 | 31.8 | 30.1 | 38 | 36.7 | 34.9 |
| viscosity at 40 F. | 390 | 380 | 270 | 150 | 230 | 280 | 170 | 200 |

Comp. Ex. 7 = Island Oasis brand Banana Mix.
Comp. Ex. 8 = Maui brand Banana Mix.

### Examples 27-28

### Margarita Mix

In the following examples, Example 27a is a mix prepared at a commercial manufacturing plant (no high shear step applied, but standard shear by pumping, etc.). Example 27b is the same composition as sample 27a, but prepared at the laboratory with no premix step given (to deliver high shear for particle size reduction). Example 28 was prepared in the laboratory with the premixing step for 1 minute, as described above, to reduce particle size.

TABLE 5
Margarita Mix

| | Ex. 27a | Ex. 28 | Ex. 27b |
|---|---|---|---|
| | (plant shear) | (premix) | (no pre-mix) |
| Ingredient | % | % | % |
| water | 69.052 | 64.7 | 69.052 |
| HFCS | 9 | 20 | 9 |
| sugar liquid | 0 | 0 | 0 |
| lime concentrate | 2.4 | 3 | 2.4 |
| lemon pulp cells | 5 | 8 | 5 |
| citric acid | 0.8 | 0.8 | 0.8 |
| sodium citrate | 0.08 | 1 | 0.08 |
| flavor emulsion, lemon | 0.09 | 0.1 | 0.09 |
| sugar | 12.16 | 0 | 12.16 |
| pectin | 1.4 | 1 | 1.4 |
| oil | 0.018 | 0 | 0.018 |
| Salt (NaCl) | | 1 | |
| Propylene Glycol Alginate | | 0.4 | |
| Total | 100 | 100 | 100 |
| starting Temp | 29.7 | 25.7 | 28.7 |
| ending temp | 36.8 | 32.4 | 35.2 |
| % separation | 24 | 12.5 | 33.3 |
| total separation ml | 105 | 120 | 160 |

TABLE 6
Insoluble Solids, Mango

| | | | Beaker Wt. | | | Dry Paper/ | Dry Wt. | % Insoluble | Average |
|---|---|---|---|---|---|---|---|---|---|
| | Sample # | Beaker Wt. | w/Sample | Sample Wt. | Filter Paper Wt | Product Wt. | (grams) | (unfiltered product) | % Insol. |
| Ex. 4 | 1 | 48.8190 | 68.8463 | 20.0273 | 0.9207 | 0.9800 | 0.0593 | 0.29610 | 0.3527 |
| Ex. 4 | 2 | 51.4329 | 71.4703 | 20.0374 | 0.8970 | 0.9790 | 0.0820 | 0.40923 | |
| Comp. 1 | 1 | 49.0920 | 69.2493 | 20.1573 | 0.8979 | 1.1324 | 0.2345 | 1.16335 | 1.0365 |
| Comp. 1 | 2 | 48.7643 | 68.9252 | 20.1609 | 0.9115 | 1.0949 | 0.1834 | 0.90968 | |
| Comp. 2 | 1 | 50.4847 | 70.5613 | 20.0766 | 0.9009 | 0.9936 | 0.0927 | 0.46173 | 0.4328 |
| Comp. 2 | 2 | 49.9272 | 70.1962 | 20.2690 | 0.8590 | 0.9409 | 0.0819 | 0.40407 | |
| Ex. 12 | 1 | 30.9727 | 51.0126 | 20.0399 | 0.9144 | 1.3240 | 0.4096 | 2.04392 | 2.0082 |
| Ex. 12 | 2 | 30.0647 | 50.1203 | 20.0556 | 0.9306 | 1.3262 | 0.3956 | 1.97252 | |

All samples were mixed with 25 ml of water before filtering.

TABLE 7
Insoluble Solids, Strawberry Daiquiri

| | | | | | | | | | % Insoluble | |
|---|---|---|---|---|---|---|---|---|---|---|
| | | | Beaker Wt. | | | | Dry Paper/ | | (unfiltered | |
| | Sample # | Beaker Wt. | w/sample | Sample Wt. | Filter Paper Wt | Wet Wt. | Product Wt. | Dry Wt. | product) | Average |
| Ex. 13 | 1 | 30.2950 | 50.3282 | 20.0332 | 0.8872 | 4.4491 | 1.0935 | 0.2063 | 1.02979 | 1.2891 |
| Ex. 13 | 2 | 30.9752 | 51.0770 | 20.1018 | 0.8827 | 5.3735 | 1.1938 | 0.3111 | 1.54762 | |
| Comp. 4 | 1 | 30.5143 | 50.7923 | 20.2780 | 0.9114 | 6.5281 | 1.1593 | 0.2479 | 1.22251 | 1.0979 |
| Comp. 4 | 2 | 30.9719 | 51.0606 | 20.0887 | 0.8850 | — | 1.0803 | 0.1953 | 0.97219 | |
| Comp. 3 | 1 | 22.3706 | 42.5825 | 20.2119 | 0.9039 | — | 0.9977 | 0.0938 | 0.46408 | 0.4475 |
| Comp. 3 | 2 | 30.7511 | 50.8949 | 20.1438 | 0.8982 | — | 0.9850 | 0.0868 | 0.43090 | |
| Ex. 14 (40%) | 1 | 30.2921 | 50.5072 | 20.2151 | 0.8899 | — | 1.1637 | 0.2738 | 1.35443 | 1.3992 |
| Ex. 14 | 2 | 30.9715 | 51.0078 | 20.0363 | 0.8895 | — | 1.1789 | 0.2894 | 1.44438 | |
| Ex. 15 (30%) | 1 | 30.5124 | 50.9032 | 20.3908 | 0.9151 | — | 1.1318 | 0.2167 | 1.06273 | 0.9223 |
| Ex. 15 | 2 | 29.4919 | 50.0982 | 20.6063 | 0.8949 | — | 1.0563 | 0.1614 | 0.78326 | |
| Ex. 16 (20%) | 1 | 29.4714 | 49.9587 | 20.4873 | 0.9082 | — | 1.0067 | 0.0985 | 0.48079 | 0.4979 |
| Ex. 16 | 2 | 29.1010 | 49.8228 | 20.7218 | 0.9069 | — | 1.0136 | 0.1067 | 0.51492 | |

While the present invention is described with respect to particular examples and preferred embodiments, it is understood that the present invention is not limited to these examples and embodiments. Additionally, the types of drink mixes that may be made are not limited to the specific types listed herein. Other types of drinks and other flavors of the drinks discussed herein are within the scope of the present invention.

Moreover, the present invention is not limited to the processing steps recited herein and may contain additional steps, such as adding or mixing steps, as would be apparent to those skilled in the art depending on what ingredients are used. Additionally, the present invention is not limited to the order of the processing steps. In particular, for example, ingredients may be added to the batch tanks in a different order than those set forth herein.

The present invention as claimed therefore includes variations from the particular examples and preferred embodiments described herein, as will be apparent to one of skill in the art.

What is claimed is:

1. A frozen fruit drink mix that does not substantially separate after being mixed with ice.

2. The mix of claim 1, wherein the mix comprises about 15% to about 75% by weight fruit content.

3. The mix of claim 2, wherein the separation after one hour at room temperature is less than about 10% (v/v).

4. The mix of claim 1, wherein the mix comprises about 15% to about 45% by weight total solids content.

5. The mix of claim 4, wherein the separation after one hour at room temperature is less than about 10% (v/v).

6. The mix of claim 1, wherein the mix is a margarita mix comprising about 17% to about 35% by weight fruit.

7. The mix of claim 1, wherein the mix is a strawberry daiquiri mix comprising about 40% to about 55% by weight fruit.

8. The mix of claim 1, wherein the mix is a piña colada mix comprising about 50% to about 75% by weight fruit.

9. The mix of claim 1, wherein the mix is a Mango mix comprising about 30% to about 40% by weight fruit.

10. The mix of claim 1, wherein the mix is a Banana mix comprising about 25% to about 40% by weight fruit.

11. The mix of claim 1, wherein the mix comprises about 30% to about 60% by weight fruit.

12. The mix of claim 1, wherein the mix comprises fruit insoluble solids having an average particle size of less than about 700 microns.

13. The mix of claim 12, wherein the fruit insoluble solids comprises mango insoluble solids having an average particle size of less than about 300 microns.

14. The mix of claim 12, wherein the fruit insoluble solids comprises at least 0.5% strawberry insoluble solids.

15. The mix of claim 1, wherein the viscosity of the mix is about 100 to about 2000 cp.

16. The mix of claim 15, wherein the viscosity of the mix is about 200 to about 1000 cp.

17. The mix of claim 1, further comprising an effective amount of a stabilizer.

18. The mix of claim 17, further comprising an effective amount of an emulsifier.

19. The mix of claim 1, wherein the mix comprises about 40% to about 55% by weight fruit; the fruit insoluble solids of the mix has an average particle size of less than about 700 microns; and the viscosity of the mix is about 200 to about 1000 cp.

20. A process for preparing a frozen fruit drink mix comprising: providing fruit solids; and reducing the average particle size of the fruit insoluble solids to less than about 700 microns.

21. The process of claim 20, wherein the reducing step comprises high shear blending or homogenizing.

22. A frozen fruit drink comprising: about 15% to about 75% by weight fruit, and ice, wherein the separation of the frozen fruit drink after one hour at room temperature is less than about 10% (v/v).
